(19) United States
(12) Patent Application Publication
(10) Pub. No.: US 2026/0072809 A1
(43) Pub. Date: Mar. 12, 2026

(54) CODE ORIGIN AND RUNTIME DUPLICITY OPTIMIZATION

(71) Applicant: DataDog Inc., New York, NY (US)

(72) Inventors: Matan Green, Tel Aviv (IL); Evgeni Wachnowezki, New York, NY (US); Omer Raviv, New York, NY (US)

(21) Appl. No.: 18/828,099

(22) Filed: Sep. 9, 2024

(51) Int. Cl. G06F 11/36

(52) U.S. Cl. CPC G06F 11/3644; G06F 11/3604

(57) ABSTRACT

The technology relates to program monitoring, which can involve using metadata as part of span information evaluated by the system in order to identify a location of interest in user (source) code. This can be used to pinpoint the exact code location that participated in a trace being debugged. The span information may be enriched with the code location from which it originated. The technology is also able to avoid unnecessary execution of instrumented functions by creating an alternate code execution path. This alternate path gets the code path to a variation of the instrumented function, in which the variation has a different set of operations. Upon determination that an execution call path has been previously followed, the alternate path would be automatically called instead of the path with the original instrumented function.

### BACKGROUND

When executing an application or other program, many computing systems may be configured to generate data in order to track or report how the program is functioning. Such data can include tracing showing how the program has executed (e.g., indicating a specific code path for the execution). For instance, a trace may be generated to represent how the program is executing for application performance monitoring (APM). Traces may be correlated to browser sessions, logs, profiles, checks, metrics, proxies, etc. APM may enable a user to, e.g., investigate slow execution to identify the specific code segment that may be causing a performance bottleneck, or otherwise evaluate a characteristic of the program.

Traces can be used to track the time spent by a program that is processing a request through a distributed system, as well as the status of that request. Each trace comprises one or more spans, in which each span may be viewed as a logical unit of work in the system for a given period of time. Traces can provide a substantial amount of information that allows users to understand the execution flow of the program. However, automated instrumentation by tracing libraries that generate spans, and thus traces, may occur within client libraries. Without runtime information attached about a method of interest such as the user's method that called the client library (like a database driver), this can diminish their usefulness. Furthermore, tracing or other operations that are performed every time the same code is executed can have high overhead in that they are computationally expensive or resource intensive, which can adversely impact the monitored process, thereby impeding evaluation of the program.

### BRIEF SUMMARY

The technology involves program monitoring, which can include, but is not limited to, enhanced APM and efficiency techniques. By way of example, this can involve using metadata as part of the span information evaluated by the system in order to identify a location of interest in user (source) code. Such information can be used to pinpoint the exact code location that participated in a trace being debugged. The span information may be enriched with the code location from which it originated in the program's logic code, and not an intermediate library, thus providing helpful origin details. Thus, the technology can enable monitoring of programs in a highly beneficial way, surfacing various execution paths within one service. For instance, code origin information for spans may be displayed as part of a graphical interface trace visualization, such as a flame graph or other graphical representation illustrating program operation, or augment code locations with APM and/or request, error, and duration (RED) metrics.

Another aspect of the technology avoids unnecessary execution of instrumented functions by creating an alternate “duplicate” code execution path. This alternate path gets the code path to a variation of the instrumented function, in which the variation has a different set of operations, e.g., which are less computationally expensive or resource intensive than the instrumented function, and thus has less overhead than the original instrumented function. Here, upon determination that an execution call path has been previously followed (including the instrumented function), the alternate path would be automatically called instead of the path with the original instrumented function. This may be referred to herein as “duplicity optimization”.

According to one aspect of the technology, a computer-implemented method is provided that comprises: identifying, by at least one processor of a computing system, execution of a program, the program having an execution call path; upon identifying the execution of the program: calling an instrumented function that is configured to perform a set of operations in order to evaluate one or more characteristics of the program; creating a duplicate of the execution call path of the program up to a point in which the instrumented function would be called; and in the duplicate, retargeting code that would call the instrumented function to instead call a variation of the instrumented function having a different set of operations; and upon determining that the execution call path of the program has been previously followed, automatically following the duplicate with the retargeted code to call the variation of the instrumented function.

The variation of the instrumented function may perform either a reduced set of operations or a subset of operations of the set of operations of the instrumented function. Alternatively or additionally, the different set of operations may be distinct from the set of operations of the instrumented function. Alternatively or additionally, at least one of the instrumented function and the variation of the instrumented function may be maintained in an instrumentation library associated with the program. Alternatively or additionally, operations to be performed by the variation of the instrumented function may have a lower overhead than the set of operations of the instrumented function.

The instrumented function may be a code origin for spans function. In this case, the code origin for spans function may be configured to perform tagging of every span in a trace with each function of the program. Here, tagging may include: performing a stack walk to find a customer authored function associated with a given one of the functions of the program; identifying which code element maps to the customer authored function; and tagging the customer authored function with information about the program and the code element. Identifying which code element maps to the customer authored function may be determined by scanning bytecode of the given function to examine any call instructions within the given function. Alternatively or additionally to any of the above, the code origin for spans function may further include placing a probe on the program with a selected bytecode offset.

Alternatively or additionally to any of the above, when the execution call path includes multiple branches that lead to the instrumented function, the method may include creating a duplicate of each branched execution call path to instead call the variation. Alternatively or additionally to any of the above, the variation of the instrumented function may be associated with a first amount of computing overhead for the computing system, and the instrumented function may be associated with a second amount of computing overhead for the computing system, the second amount being greater than the first amount.

Alternatively or additionally to any of the above, the method may further comprise: upon calling the instrumented function, gathering information in response to performance of the set of operations; wherein either creating the duplicate of the execution call path or retargeting the code includes embedding at least a portion of the information in bytecode along an execution call path associated with the variation of the instrumented function. Alternatively or additionally to any of the above, creating the duplicate of the execution call path may be performed dynamically at runtime.

According to another aspect of the technology, a processing system is provided that comprises memory configured to store information associated with a program, and one or more processors operatively coupled to the memory. The one or more processors are configured to identify execution of the program, wherein the program has an execution call path. Upon identification of the execution of the program, the one or more processors are further configured to: call an instrumented function that is configured to perform a set of operations in order to evaluate one or more characteristics of the program, create a duplicate of the execution call path of the program up to a point in which the instrumented function would be called, and in the duplicate, retarget code that would call the instrumented function to instead call a variation of the instrumented function having a different set of operations. Upon determination that the execution call path of the program has been previously followed, the one or more processors are configured to automatically follow the duplicate with the retargeted code to call the variation of the instrumented function.

The variation of the instrumented function may be configured to perform either a reduced set of operations or a subset of operations of the set of operations of the instrumented function. The different set of operations may be distinct from the set of operations of the instrumented function. Operations to be performed by the variation of the instrumented function may have a lower overhead than the set of operations of the instrumented function. The instrumented function may be a code origin for spans function. 20. And the variation of the instrumented function may be associated with a first amount of computing overhead for the processing system, while the instrumented function may be associated with a second amount of computing overhead for the processing system, in which the second amount is greater than the first amount.

### BRIEF DESCRIPTION OF THE DRAWINGS

FIGS. 1A-B illustrate an exemplary system and scenario in accordance with aspects of the technology.

FIG. 2 illustrates an example code origin approach in accordance with aspects of the technology.

FIG. 3 illustrates an exemplary visualization of a code origin approach in accordance with aspects of the technology.

FIG. 4 illustrates example pseudocode for an instrumented function in accordance with aspects of the technology

FIGS. 5A-B illustrate example pseudocode and a causality chain in accordance with aspects of the technology.

FIGS. 6A-B illustrate an example duplicity optimization process in accordance with aspects of the technology.

FIGS. 7A-C illustrate an example branched duplicity optimization process in accordance with aspects of the technology.

FIG. 8 is a system diagram in accordance with aspects of the technology.

FIG. 9 illustrates an example method in accordance with aspects of the technology.

### DETAILED DESCRIPTION

As noted above, the technology involves enhanced APM and efficiency techniques, both to identify beneficial code origin for span details to evaluate program execution, and reduce or eliminate situations where instrumented functions would be repeatedly called when the additional calls may not aid or could potentially degrade performance monitoring. In the former case, conventional traces may not include certain useful or otherwise important information. For instance, when the traces need to be matched to the code that was responsible for generating them, e.g., for debugging purposes, this is not always possible because the link may not be immediately obvious from the data attached to the spans. Thus, metadata related to a corresponding code location in the user (source) code is employed to identify the specific code location involved in a trace being debugged.

The code origin for spans technique, or another instrumented function, may gather significant amounts of data in real time as the program is executing, in order for the system to perform the code evaluation. By way of example, the program's code may originate in a customer code library, and the program may then call one or more functions from another library (e.g., a third-party open-source library). The instrumented function may be part of one of these libraries, or may be maintained in a different library, such as an instrumentation or other support library. Regardless, if the instrumented function is called every time the code executes, it may be computationally expensive or resource intensive without providing meaningful information beyond what was obtained the first time that function was called. This issue may be compounded when there are thousands, tens of thousands, or millions of code executions to monitor. Thus, duplicity optimization can be employed to significantly reduce the overhead involved in APM and general program execution.

The following sections discuss the code origin for spans approach, followed by the duplicity optimization approach.

### Code Origin for Spans

During application execution, a trace may be generated, which represents how the application is executing for APM purposes. In particular, a trace represents a workflow, which can track the amount of time spent by the application to process a request as well as the status of a request. A given trace comprises a set of operations that represents a unique transaction handled by an application and its services. Each trace includes one or more spans, where a span corresponds to a logical unit of work for a given period of time. Each span can be equivalent to one event, and has a corresponding numerical identifier (ID). Together with trace IDs, the span IDs can be used to correlate traces and logs in a computing system. The execution time of a span is the total time that the span is active, which can include time spent waiting for a child span to complete.

Tags may be applied to spans, such as in the form of a key-value pair, in order to correlate a request with other telemetry information or to filter the request in searches. Tags can be applied to describe one or more of: attributes present on all spans, what instrumentation is used and the kind of operation, work units corresponding to network communication, HTTP client and server spans, database spans, messaging system spans, spans corresponding to remote procedure calls (RPCs), errors associated with spans, etc. Thus, span tags can provide context around the span. In contrast, span attributes are the content of the span.

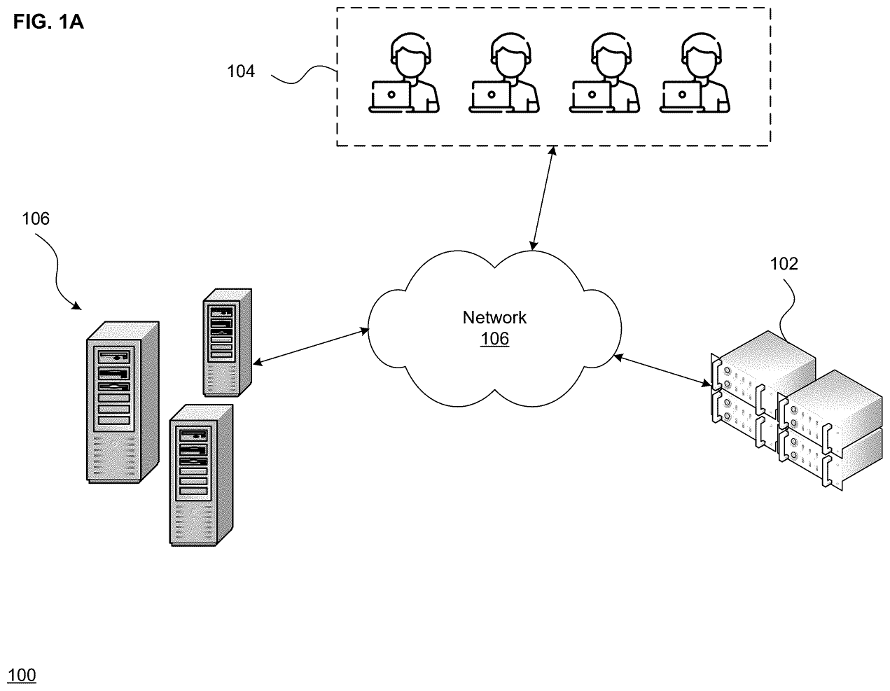

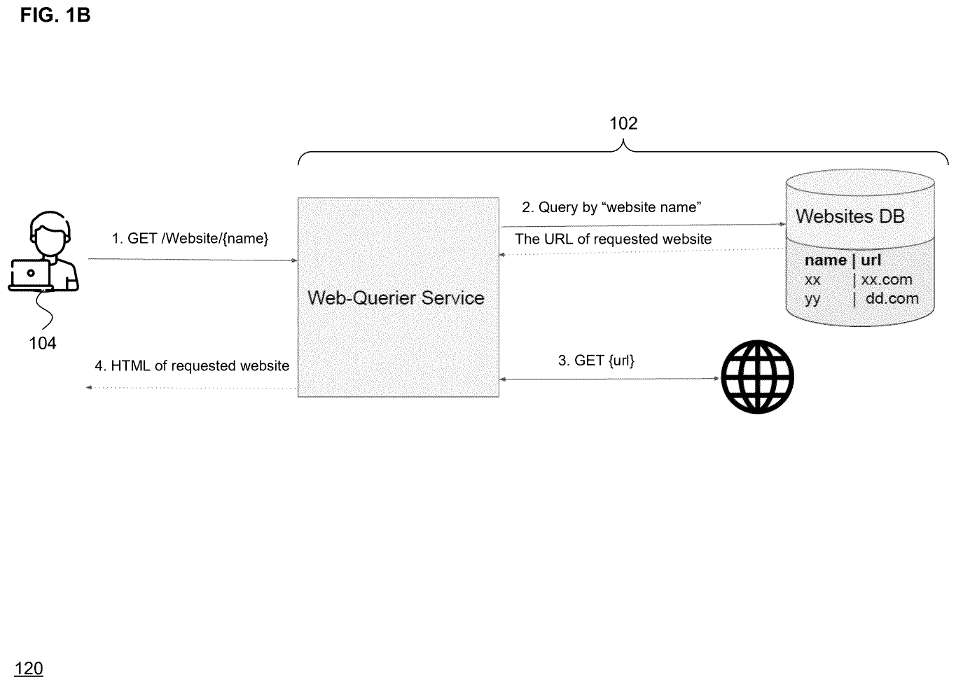

FIG. 1A illustrates an exemplary system 100, which includes a web server or other client service 102, a set of end users 104 that interact with the service 102 via a network 106, and optionally a backend service 106 that can provide support tools such as instrumented functions to the client service 102. By way of example only, the client service 102 may support one or more websites, and the end users 104 may send requests or queries to, and receive information from, the client service 102 regarding certain websites. FIG. 1B illustrates an example 120 of a website query, in which the computing device of the end user 104 sends a query to the service 102 (“GET/Website/{name}”) as shown at (1). The service, as shown at (2), queries a websites database by “website name”, and at (3) obtains the URL of the requested website (“GET {url}”). Then at (4), the URL is then used to return the HTML of the requested website to the end user 104.

In this scenario, it can be helpful to evaluate how the code of the client service 102 is performing. This can be done by debugging a trace of the code. As noted above, matching a trace to the code may not always be possible because the link may not be immediately obvious from the data attached to spans. To address this issue, a tracer tool such as one for code origin for spans can be employed.

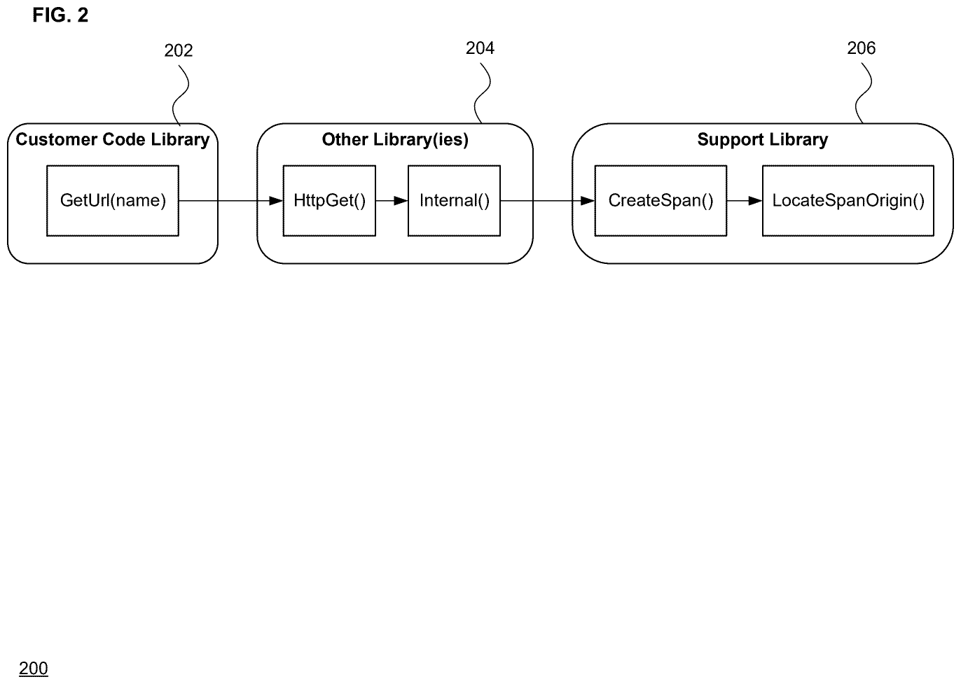

FIG. 2 illustrates an exemplary approach 200 for the code origin for spans process. As shown, there may be multiple code libraries (code bases), including a customer code library 202, one or more other (e.g., third party) libraries 204 and/or a support library 206 (e.g., an instrumentation library). For instance, the libraries 202 and 204 may be associated with client service 102, while the support library 206 may be associated with support service 106. Or, alternatively, all of the code libraries/code bases may be associated with the client service 102 (or the support service 106). While shown as distinct libraries, other configurations can be employed. For example, the libraries 202, 204 and/or 206 may be a single library. The library or libraries may be managed by or otherwise associated with the client service 102 and/or the backend service 106 of FIG. 1.

The code origin for spans approach involves tagging every span in a trace with the method (e.g., a function or operation, or a set of functions or operations) and code segment of interest (e.g., file and line(s)) that executes that method. This process may occur at runtime based on executable code (e.g., machine code for Go or intermediate bytecode for Java). Thus, the approach may be used to identify relevant function names, function calls, and/or file offsets. The approach involves the following: performing a stack walk to find the relevant method, scanning the method's bytecode to identify which portion (e.g., user or non-library portion) yields the span by examining the call instructions, and tagging the span with the method and code information.

This process is indicated in FIG. 2, where the code of interest found in customer code library 202 is “GetUrl(name)”. This code calls into “HttpGet( )” in the library 204, which may itself call into one or more other methods/functions (e.g., “Internal( )”). Based on this, the approach creates a span via “CreateSpan( )” and uses “LocateSpanOrigin( )” to perform the code origin stack walking operation. As shown, the span creation and code origin for spans methods are in the support library 206. This approach can include placing a probe on the called method (“HttpGet( )”), with a selected bytecode offset. In one scenario, probes can be placed on every method that represents an endpoint of the associated customer code. For each probe, this can include choosing service, environment, version, and probe location information. Note that probes can be implemented by the system without halting or impacting execution of the program/app.

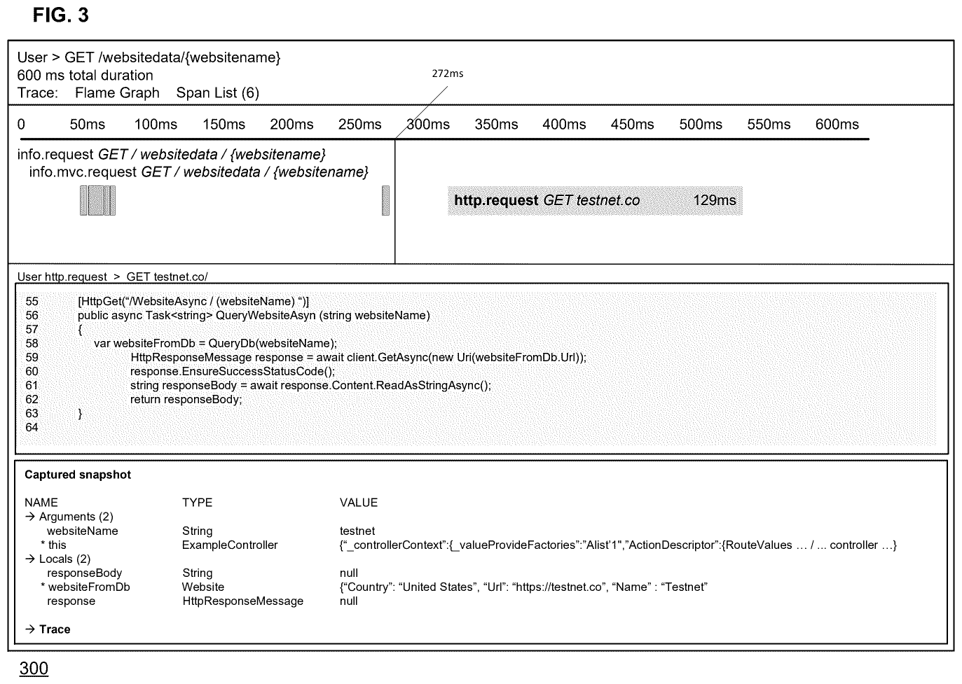

FIG. 3 illustrates an exemplary visualization 300 of the code origin for spans approach, as it may be presented in a graphical user interface (GUI) of a computing device. This visualization shows the relevant method and active span in a flame graph type visualization illustrating the execution of the full trace, for the website name query of FIG. 1B. No debug information is illustrated in this example.

### Duplicity Optimization

Instrumentation involves adding code to an application to capture and report observability data. This can be done via instrumented functions, such as the stack trace approach discussed above. In that approach, there is an overhead impact associated with performing a stack walk as it captures information about the method that can be stored in system memory and processed to identify the origin of the code of interest.

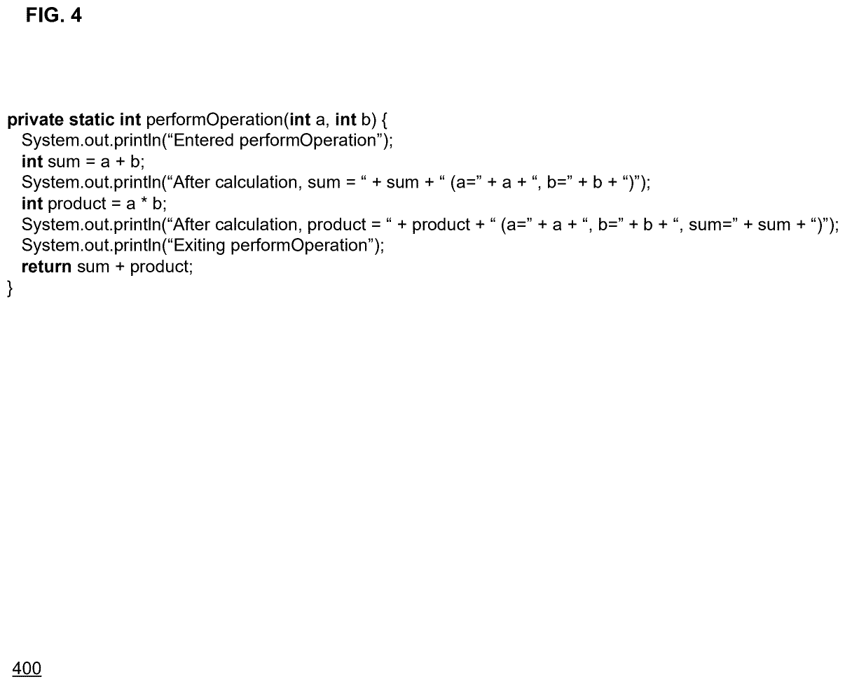

Instrumented functions may have a significant overhead impact. For instance, FIG. 4 illustrates an example 400 of pseudocode for an instrumented function that performs detailed logging after each operation or line of code. While this details the execution context and all available variables, employing this function with many methods would result in very high overhead that may require significant processing power and memory resources for data storage. In particular, such functions can have numerous limitations, including logging granularity, performance impact, and hidden performance costs.

With regard to logging granularity, continuous logging at this level may be impractical due to the excessive data volume, which can potentially obscure rather than clarify issues with the code being evaluated. By way of example, presenting results via a flame graph or other graphical representation for the detailed logging example may mask issues impacting actual operation of the method under evaluation. Tailored logging for specific scenarios, such as investigating actions of a particular user like “John Smith” or a particular set of IP addresses can be more effective. Once could also implement remote logging activation or use a percentage-based approach for random logging.

Regarding performance impact, extensive logging can introduce significant execution overhead, both financially in terms of storage and data processing, and performance-wise as it can degrade execution efficiency of the system. Moreover, there can be hidden performance costs. For example, even with sample-based logging, the decision-checking process between each line of code can incur unwanted costs.

Duplicity optimization can mitigate these and other issues by creating an alternate, lower overhead instrumented function. This alternate function can be called in situations where the original, higher overhead function is not needed or would not provide meaningful new information if it were to be called multiple times.

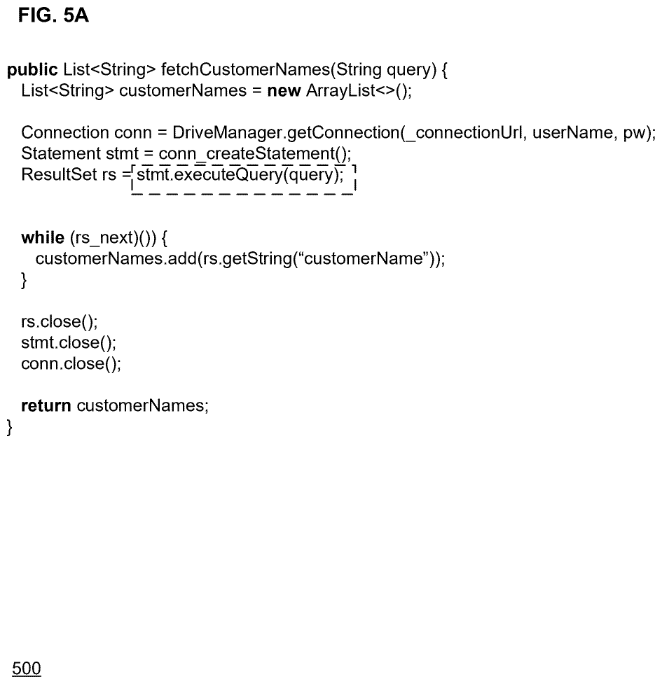

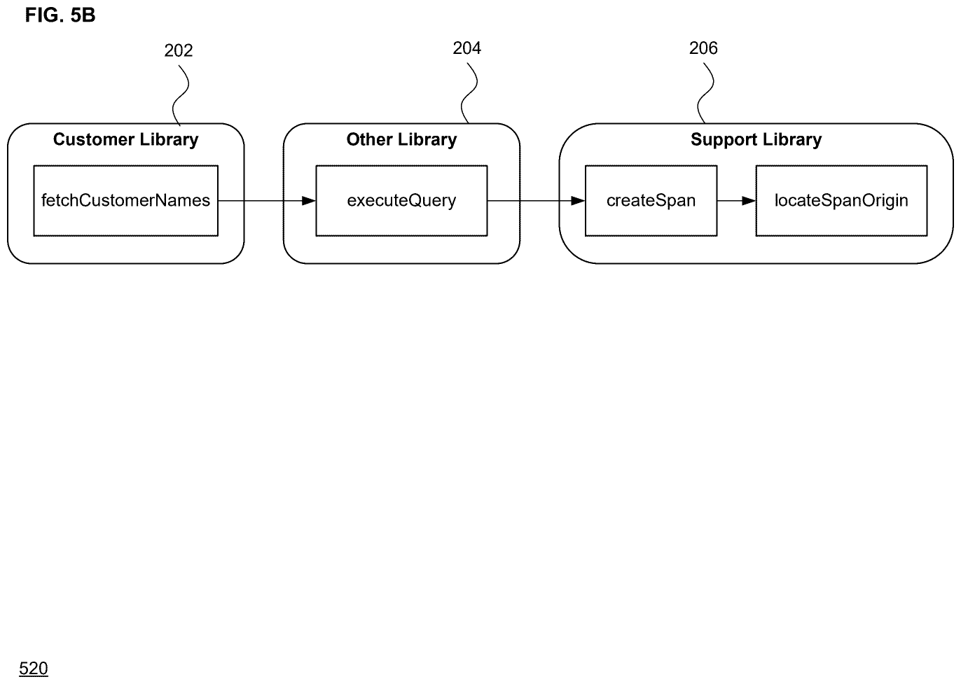

FIG. 5A illustrates an example snippet 500 of Java code for a method to perform a database query. Here, the “stmt. executeQuery(query)” in the box is the method to create a new span. In particular, executing the instrumented method executeQuery(q) triggers a new span. FIG. 5B illustrates the chain of causality for the method of FIG. 5A. As with the example 200 in FIG. 2, the support library also includes the code origin for spans function (“locateSpanOrigin”), which in this scenario would be triggered upon creating a new span.

The locateSpanOrigin function may be considered a comprehensive or complex function. Ideally, the locateSpanOrigin method would be called only once per execution path, as the method and code for each path remains (fetchCustomerNames→executeQuery→createSpan→locateSpanOrigin) constant throughout the application's lifetime. This would also be true for many other types of comprehensive or complex instrumented functions. Thus, according to one aspect of the technology, a duplicated (alternate) path is created that instantiates a reduced overhead variant of the instrumented function. The reduced overhead variant may be considered a streamlined, focused or tailored function that can be executed faster than the original comprehensive or complex function. This duplicated path retargets the code path to the instrumented function variant instead of the original instrumented function. The variant is configured to perform a different set of operations that are less computationally expensive or resource intensive than the original instrumented function, thus being streamlined, focused or tailored. The different set of operations can be a subset of operations performed by the original function, or an alternative set of one or more operations which may be entirely different than the operations performed by the original function. The operations of the variant are configured to have a lower overhead cost than the operations of the original instrumented function.

As discussed below, the retargeting may include modifying the running/loaded bytecode of the code of interest, which may be from the customer code library. In particular, the execution path from the relevant part of the program (e.g., starting from the code in a customer library) is duplicated all the way up to but not including the instrumented function (which may be stored, e.g., in an instrumentation library). The relevant part of the program need not (and in many instances would not) be the absolute origin of the program.

The duplicity optimization process copies the bytecode along the call path, retargeting the bytecode by mutating the call instruction that would call the next function in the chain (the high overhead instrumented function), to instead call an alternative, “variant” function that does not include some or all of the operations of the instrumentation function. This approach of code modification and alternative execution paths would be transparent to the client system running the code, e.g., client service 102 of FIGS. 1A-B, while still providing the benefit of the code origin or other instrumented function for unique code execution paths. In situations where there are multiple branches within the code execution path that lead to the original instrumented function, the process may duplicate all such paths in order to call the variant instead of the original instrumented function.

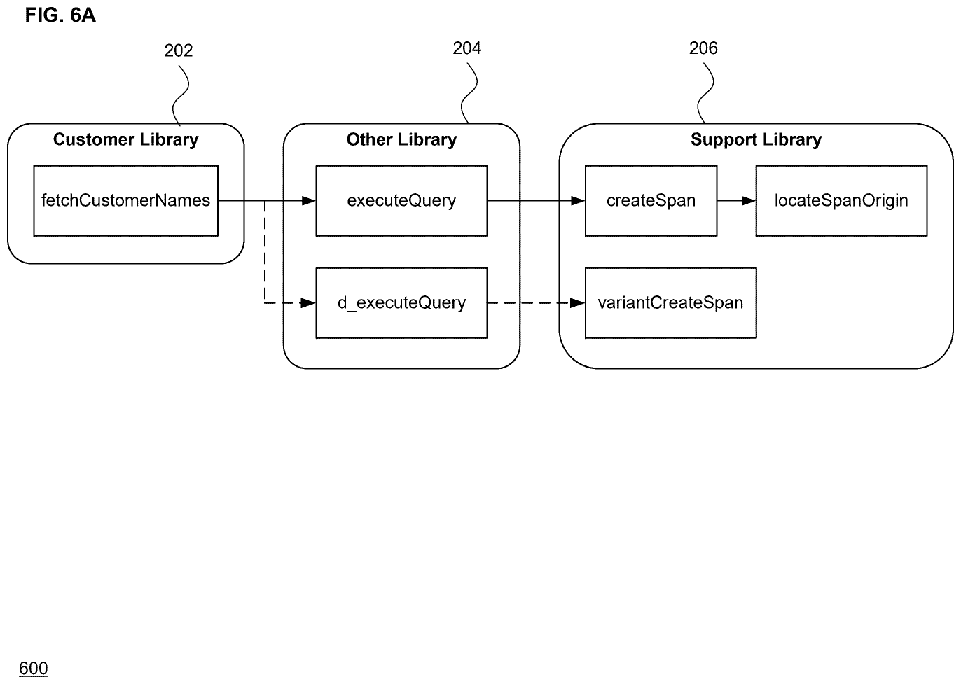

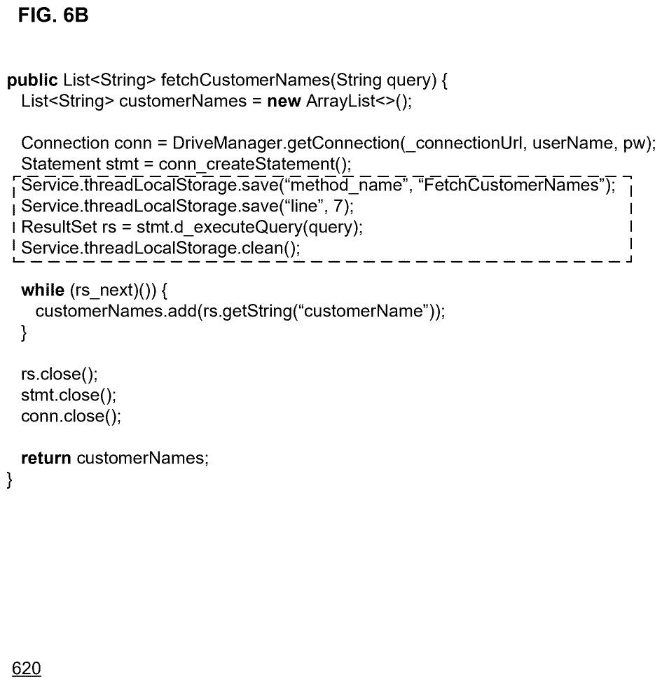

FIG. 6A illustrates an example 600 of the duplicity optimization process. In this example, the first time fetchCustomerNames is called, it proceeds as shown in FIG. 5B, in which executing the instrumented method executeQuery triggers a new span, which in turn calls the code origin function (locateSpanOrigin). While this example involves the code origin for spans function, any other instrumented function could be called that is configured to perform a set of operations in order to evaluate one or more characteristics of the program. At runtime of executeQuery (which will cause the code origin function to trigger), a duplicate is dynamically created called d_executeQuery. The duplicate contains the same stream of bytecode as executeQuery, except instead of calling createSpan it is configured to call variantCreateSpan. This variant has a different set of operations than locateSpanOrigin (or different operations than any other instrumented function that it is replacing).

When the duplicate path is dynamically created, the method of interest (here, fetchCustomerNames) is instrumented (mutated) to point to d_executeQuery. Thus, any subsequent time that fetchCustomerNames is called, as shown by the dotted arrows first d_executeQuery is called, which in turn calls variantCreateSpan. An example 620 of pseudocode in FIG. 6B illustrates what the instrumented method of interest is changed to. This optimization not only allows efficient alternation between high-overhead and low-overhead execution paths, but also enables attaching additional context to the customer code, gathered once and reusable throughout the same call path.

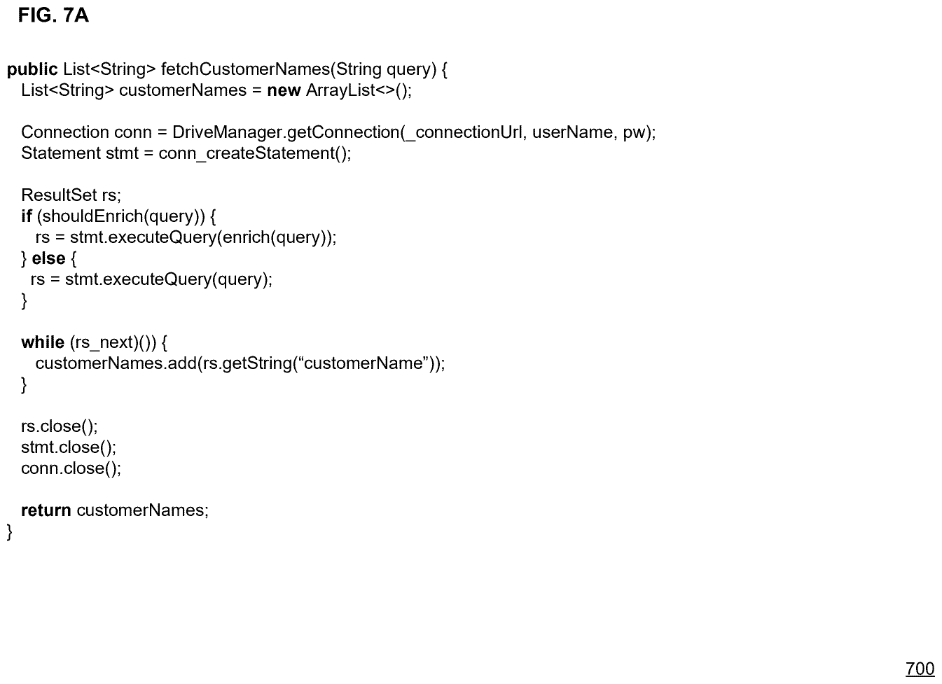

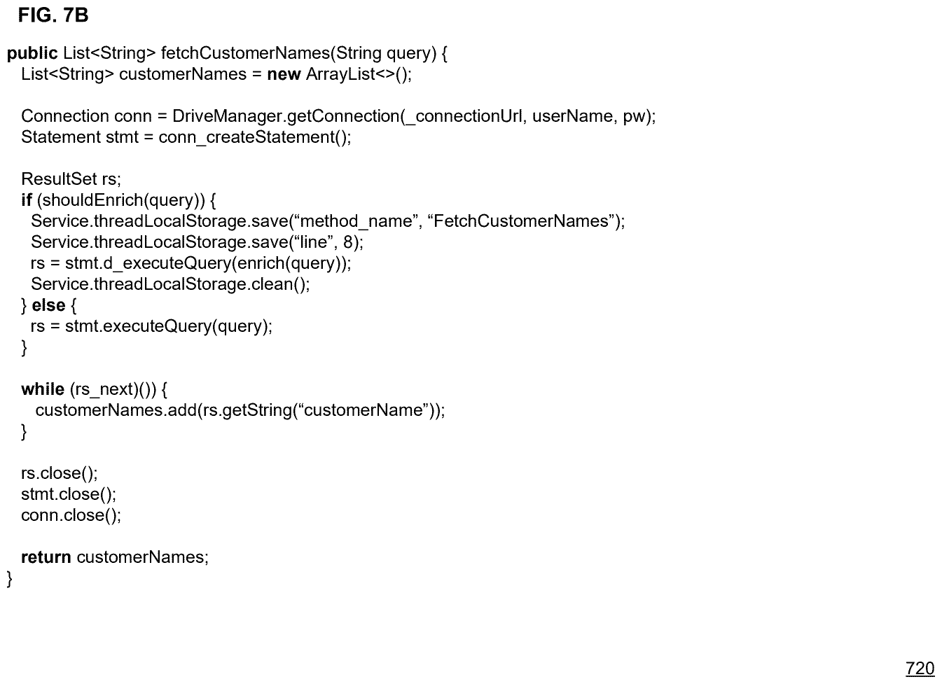

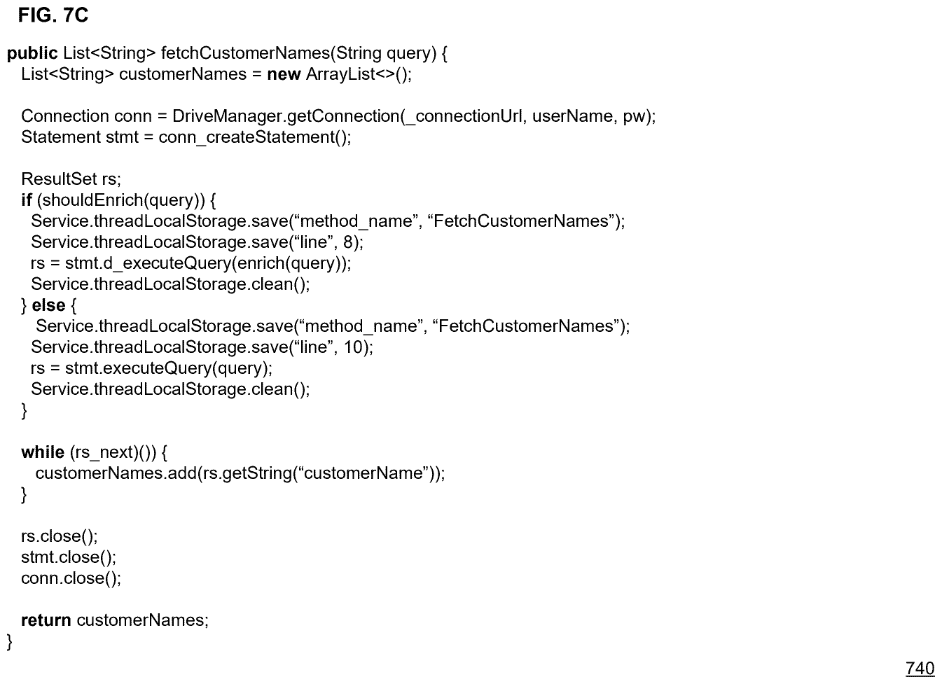

FIGS. 7A-C illustrate a more complex scenario with branches. FIG. 7A illustrates the original code 700 for the method of interest. Here, a branch leads to two different spans: one via stmt. executeQuery(query) and another via stmt. executeQuery(enrich(query)). Assuming the first method execution enters the first branch, as shown by example code 720 of FIG. 7B, only the first branch bypasses the high-overhead execution path, leaving the second branch unchanged. And example code 740 of FIG. 7C illustrates what would happen upon entering the second branch. Note that all methods are duplicated between fetchCustomerNames and the original createSpan function, rerouting method calls to alternate duplicates.

The reduced overhead variant, which may be a streamlined, focused or tailored version of the original comprehensive or complex function, can be stored in the support library 206 along with the original function. These functions may be stored in a persistent version of the support that is packaged with customer code (which may include library 202 and/or library 204). Alternatively, the original function and the variant of the function may be stored with the customer code (e.g., in library 202 and/or library 204). The original function and the variant may be added either at build time via compiling or at the instantiation time of the process executing the customer's code. Note that the duplicate path may only be created at runtime.

Once the original (expensive) operation is performed and information is gathered according to that operation, the system may embed some or all of that information in the code (e.g., machine code or bytecode) of the method of interest, where the method call is then redirected to call the reduced overhead variant.

As noted above, while code origin for spans is one example of an instrumented function that can be implemented with the technology discussed herein, many other types of instrumented functions can also be employed and the technology is not limited to any particular instrumented function.

By way of example, another type of instrumented function is called “time travel debugging”. Here, for incoming requests, the system can perform a sampling decision select a percentage of requests (e.g., 1% of requests, between 2-10% of requests, or no more than 5% of requests) to go through the selected (high overhead) processing. The system would capture all variables and information for that selected subset, and not perform the capture for the non-selected requests. By way of example, the system could measure the application at runtime to see how many requests are received within a given time window, and then decide when or what to sample. This would tie how much high overhead processing is performed to the overall workload of the application. Alternatively, a machine learning algorithm could be employed to make the sampling decision or which requests to go through the high overhead processing.

A further type of instrumented function involves network or system security. Here, if there is a vulnerable library and it is important to make sure if the library gets called, a selected process could be notified so that the vulnerability does not get exploited. In this case, the selected process can choose a different execution flows to avoid a possible vulnerability, for example by matching the payload to one or more patterns used in an exploit. Here, the system would determine in which parts of the code or which methods the security issue may occur, and then branch off to avoid the problem.

### EXAMPLE SYSTEM ARCHITECTURE

The approaches discussed herein, e.g., the code origin approach and the duplicity optimization approach, either employed individually or in combination, can provide rich information for APM purposes, while reducing potential overhead issues.

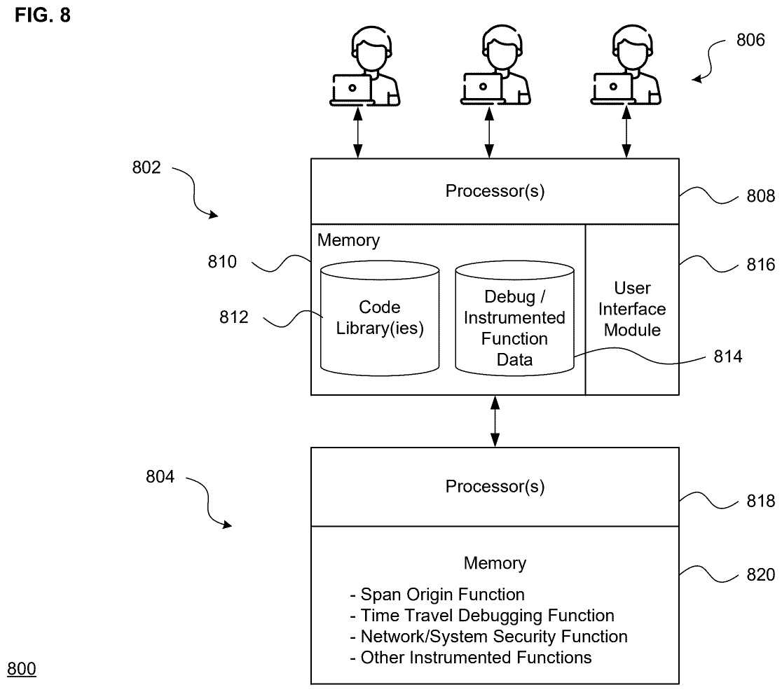

FIG. 8 illustrates an example system architecture 800 that can implement the approaches discussed herein. This example system architecture includes a first system 802 and a second system 804. The first system 802 may be, e.g., a client service including one or more servers that receive queries or other requests from users'client computing devices 806, and provide information responsive to those requests. The second system 804 may be a backend service that is configured to support the APM needs of the client service, e.g., by providing an instrumentation library and/or other tools to aid in performance monitoring.

The first system 802, second system 804, and the client computing devices 806 may communicate directly or indirectly via a computer network (or multiple networks). The network, and intervening nodes, may include various configurations and protocols including, by way of example only, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

The first system 802 may include, e.g., one or more web servers, database servers or storage devices that are configured to communicate with various client computing devices 806. System interactions with the client computing devices 806 may be response to user interactions (e.g., search queries, browsing, clicking, purchasing actions of end user devices such as desktops, laptops, tablets, mobile phones, smartwatches, etc.). While not shown, the client computing devices 806 may include laptops or desktop computers, as well as mobile phones, tablet PCs, smartwatches, head-mounted displays or other wearables, etc. Alternatively or additionally, the devices 806 could also be other servers performing other kinds of operations that require the information that the system 802 can provide.

The servers may be part of a single server rack, a server farm, a cloud-based server system or the like. As shown, the first system 802 includes one or more processors 808 and memory 810. The memory 810 may store instructions for implementing selected methods (functions) when executed by one or more of the processors 808. The memory 810 in this example architecture includes one or more code libraries 812, such as customer code library 202, other (e.g., third party) libraries 204 and/or a support library 206 (e.g., an instrumentation library) as shown in FIG. 2. The memory 810 may also store instrumented function data 814 or other debug information, for instance upon execution of a code origin function or other instrumented function. The first system 802 may also include a user interface module 816, which is configured to present information to a user, e.g., as part of an APM evaluation. Here, the user interface module 816 may be configured to generate one or more visualizations, such as a flame graph or other graphical representation illustrating program operation.

The second system 804 includes one or more processors 818 and memory 820. The memory 820 can maintain one or more instrumented functions (e.g., a code origin function, a time travel debugging function, a network or system security function, and/or other types of instrumented functions). In some scenarios, the second system may maintain the instrumented functions in a support library accessible by the first system 802.

The memories 810 and 818 may be of any type capable of storing information accessible by the processor(s), including a computing device-readable medium. The memories are non-transitory media such as a hard-drive, memory card, optical disk, solid-state, etc. Systems may include different combinations of the foregoing, whereby different portions of the instructions and data are stored on different types of media.

The instructions may be any set of instructions to be executed directly (such as machine code) or indirectly (such as scripts) by the processor(s) 806, 816. For example, the instructions may be stored as computing device code on the computing device-readable medium. In that regard, the terms “instructions”, “modules”, “methods”, and “programs” may be used interchangeably herein. The instructions may be stored in object code format for direct processing by the processor, or in any other computing device language or format including scripts or collections of independent code modules that are interpreted on demand or compiled in advance. The instructions may enable the processor(s) to perform any of the approaches discussed above.

The processors 808, 818 may be any hardware-type processors, such as commercially available CPUs, TPUs, etc. Alternatively, each processor may be a dedicated device such as an ASIC or other hardware-based processor. Although FIG. 8 illustrates the processor(s) and memory of each system 802, 804 as being together, such devices may actually include multiple processors, computing devices, or memories that may or may not be stored within the same physical housing. Similarly, the memory may be a hard drive or other storage media located in a housing different from that of the processor(s), for instance in a cloud computing system. Accordingly, references to a processor or computing device will be understood to include references to a collection of processors or computing devices or memories that may or may not operate in parallel.

Moreover, reference to “one or more processors” herein includes situations where a set of processors may be configured to perform one or more operations. Any combination of such a set of processors may perform individual operations or a group of operations. This may include two or more CPUs or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The example 800 of FIG. 8 illustrates a small number of devices 802, 804 and 806. In practice, there may be any number of servers or other computing devices of the services 802 and 804, as well as any number of client computing devices 806 (e.g., tens, hundreds, thousands or more of such devices 814). In one scenario, the first system 802 may maintain the relevant libraries, implement the code origin for spans approach that includes performing a stack walk to find the relevant method, scanning the method's bytecode to identify which portion yields the span by examining the call instructions, and tagging the span with the method and code information. The first system may then generate a visualization or otherwise present relevant information to aid in evaluation of the customer code. In another scenario, the first system 802 may perform duplicity optimization as described above. Alternatively, the second system 804 may perform some or all of these operations. In a further scenario, there may be only one system (e.g., the second system 804 may be omitted).

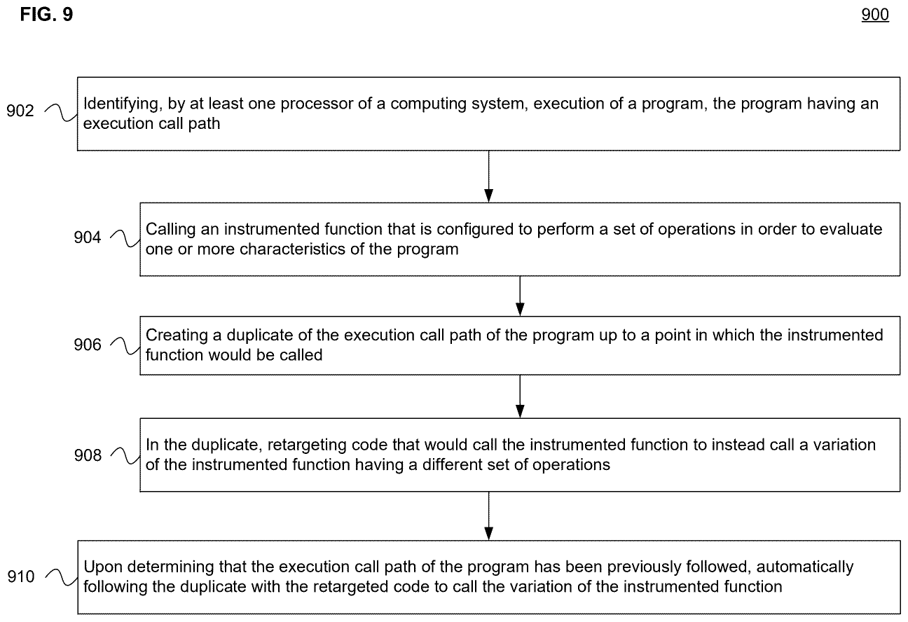

FIG. 9 illustrates an example method 900 in accordance with aspects of the technology. As shown in block 902, the method includes identifying, by at least one processor of a computing system, execution of a program, wherein the program has an execution call path. Upon identifying execution of the program, at block 904 the method includes calling an instrumented function that is configured to perform a set of operations in order to evaluate one or more characteristics of the program, at block 906 creating a duplicate of the execution call path of the program up to a point in which the instrumented function would be called, and at block 908, in the duplicate, retargeting code that would call the instrumented function to instead call a variation of the instrumented function having a different set of operations. Then, at block 910, upon determining that the execution call path of the program has been previously followed, the method includes automatically following the duplicate with the retargeted code to call the variation of the instrumented function.

Although the technology herein has been described with reference to particular embodiments and scenarios, it is to be understood that these embodiments and scenarios are merely illustrative of the principles and applications of the present technology. It is therefore to be understood that numerous modifications may be made to the illustrative embodiments and scenarios, and that other arrangements may be devised without departing from the spirit and scope of the present technology as defined by the appended claims.

Moreover, unless expressly stated otherwise, the foregoing examples and arrangements are not mutually exclusive and may be implemented in various ways to achieve unique advantages. By way of example only, the merging approach for multiple sketches may be utilized with any of the other algorithms discussed herein. These and other variations and combinations of the features discussed herein can be employed without departing from the subject matter defined by the claims. In view of this, the foregoing description of exemplary embodiments should be taken by way of illustration rather than by way of limitation.

The examples described herein, as well as clauses phrased as “such as,” “including” and the like, should not be interpreted as limiting the subject matter of the claims to any specific examples. Rather, such examples are intended to illustrate possible embodiments. Further, the same reference numbers in different drawings can identify the same or similar elements. The processes or other operations may be performed in a different order or concurrently, unless expressly indicated otherwise herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. As used in this document, “each” refers to each member of a set or each member of a subset of a set.

1. A computer-implemented method, comprising:
identifying, by at least one processor of a computing system, execution of a program, the program having an execution call path;
upon identifying the execution of the program:
calling an instrumented function that is configured to perform a set of operations in order to evaluate one or more characteristics of the program;
creating a duplicate of the execution call path of the program up to a point in which the instrumented function would be called; and
in the duplicate, retargeting code that would call the instrumented function to instead call a variation of the instrumented function having a different set of operations; and
upon determining that the execution call path of the program has been previously followed, automatically following the duplicate with the retargeted code to call the variation of the instrumented function.

2. The method of claim 1, wherein the variation of the instrumented function performs either a reduced set of operations or a subset of operations of the set of operations of the instrumented function.

3. The method of claim 1, wherein the different set of operations is distinct from the set of operations of the instrumented function.

4. The method of claim 1, wherein at least one of the instrumented function and the variation of the instrumented function is maintained in an instrumentation library associated with the program.

5. The method of claim 1, wherein operations to be performed by the variation of the instrumented function have a lower overhead than the set of operations of the instrumented function.

6. The method of claim 1, wherein the instrumented function is a code origin for spans function.

7. The method of claim 6, wherein the code origin for spans function is configured to perform tagging of every span in a trace with each function of the program.

8. The method of claim 7, wherein tagging includes:
performing a stack walk to find a customer authored function associated with a given one of the functions of the program;
identifying which code element maps to the customer authored function; and
tagging the customer authored function with information about the program and the code element.

9. The method of claim 8, wherein identifying which code element maps to the customer authored function is determined by scanning bytecode of the given function to examine any call instructions within the given function.

10. The method of claim 6, wherein the code origin for spans function further includes placing a probe on the program with a selected bytecode offset.

11. The method of claim 1, wherein when the execution call path includes multiple branches that lead to the instrumented function, the method includes creating a duplicate of each branched execution call path to instead call the variation.

12. The method of claim 1, wherein the variation of the instrumented function is associated with a first amount of computing overhead for the computing system, and the instrumented function is associated with a second amount of computing overhead for the computing system, the second amount being greater than the first amount.

13. The method of claim 1, further comprising:
upon calling the instrumented function, gathering information in response to performance of the set of operations;
wherein either creating the duplicate of the execution call path or retargeting the code includes embedding at least a portion of the information in bytecode along an execution call path associated with the variation of the instrumented function.

14. The method of claim 1, wherein creating the duplicate of the execution call path is performed dynamically at runtime.

15. A processing system, comprising:
memory configured to store information associated with a program; and
one or more processors operatively coupled to the memory, the one or more processors being configured to:
identify execution of the program, the program having an execution call path;
upon identification of the execution of the program:
call an instrumented function that is configured to perform a set of operations in order to evaluate one or more characteristics of the program;
create a duplicate of the execution call path of the program up to a point in which the instrumented function would be called; and
in the duplicate, retarget code that would call the instrumented function to instead call a variation of the instrumented function having a different set of operations; and
upon determination that the execution call path of the program has been previously followed, automatically follow the duplicate with the retargeted code to call the variation of the instrumented function.

16. The processing system of claim 15, wherein the variation of the instrumented function is configured to perform either a reduced set of operations or a subset of operations of the set of operations of the instrumented function.

17. The processing system of claim 15, wherein the different set of operations is distinct from the set of operations of the instrumented function.

18. The processing system of claim 15, wherein operations to be performed by the variation of the instrumented function have a lower overhead than the set of operations of the instrumented function.

19. The processing system of claim 15, wherein the instrumented function is a code origin for spans function.

20. The processing system of claim 15, wherein the variation of the instrumented function is associated with a first amount of computing overhead for the processing system, and the instrumented function is associated with a second amount of computing overhead for the processing system, the second amount being greater than the first amount.
